(19) United States
(12) Patent Application Publication
(10) Pub. No.: US 2021/0224064 A1
(43) Pub. Date: Jul. 22, 2021

(54) EXPERTISE SCORE VECTOR FOR SOFTWARE COMPONENT MANAGEMENT

(71) Applicant: International Business Machines Corporation, Armonk, NY (US)

(72) Inventors: Andrew C. M. Hicks, Wappingers Falls, NY (US); Michael Terrence Cohoon, Fishkill, NY (US); RYAN THOMAS RAWLINS, New Paltz, NY (US); MICHAEL E. GILDEIN, Wappingers Falls, NY (US)

(21) Appl. No.: 16/749,017

(22) Filed: Jan. 22, 2020

(51) Int. Cl. G06F 8/77; G06Q 10/06

(52) U.S. Cl. CPC G06F 8/77; G06Q 10/06398; G06Q 10/063112

(57) ABSTRACT

Techniques for an expertise score vector for software component management are described herein. An aspect includes maintaining a plurality of metrics in an expertise score vector corresponding to a developer. Another aspect includes identifying a subset of the plurality of metrics that are relevant to a work item corresponding to a software component. Another aspect includes applying respective weights to the subset of the plurality of metrics. Another aspect includes determining an expertise score for the developer based on the weighted subset of the plurality of metrics, wherein determining the expertise score comprises determining a magnitude of a vector comprising the weighted subset of the plurality of metrics. Another aspect includes assigning the work item to the developer based on the expertise score.

### BACKGROUND

The present invention generally relates to computer systems, and more specifically, to an expertise score vector for software component management in a computer system.

Computer systems control almost every aspect of our life—from writing documents to controlling traffic lights. Such computer systems are controlled by software components that may be written by teams of software developers. The software components may be relatively complex, requiring relatively large numbers of developers working together to produce and maintain computer code that is executed on a computer system. Further, computer systems may be often error-prone, and thus require a testing phase in which any errors should be discovered. The testing phase is considered one of the most difficult tasks in designing a computer system. The cost of not discovering an error may be enormous, as the consequences of the error may be disastrous.

### SUMMARY

Embodiments of the present invention are directed to an expertise score vector for software component management. A non-limiting example computer-implemented method includes maintaining a plurality of metrics in an expertise score vector corresponding to a developer. The method also includes identifying a subset of the plurality of metrics that are relevant to a work item corresponding to a software component. The method also includes applying respective weights to the subset of the plurality of metrics. The method also includes determining an expertise score for the developer based on the weighted subset of the plurality of metrics, wherein determining the expertise score comprises determining a magnitude of a vector comprising the weighted subset of the plurality of metrics. The method also includes assigning the work item to the developer based on the expertise score

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of an example computer system for use in conjunction with one or more embodiments of an expertise score vector for software component management;

FIG. 2 is a flow diagram of a process for software component management using an expertise score vector in accordance with one or more embodiments of the present invention;

FIG. 3 is a flow diagram of a process for determination of a regression testing metric for an expertise score vector for software component management in accordance with one or more embodiments of the present invention;

FIG. 4 is a flow diagram of a process for determination of a problem records metric for an expertise score vector for software component management in accordance with one or more embodiments of the present invention;

FIG. 5 is a flow diagram of a process for determination of a code review change metric for an expertise score vector for software component management in accordance with one or more embodiments of the present invention; and

FIGS. 6A and 6B are block diagrams of components of a system for an expertise score vector for software component management in accordance with one or more embodiments of the present invention.

### DETAILED DESCRIPTION

One or more embodiments of the present invention provide an expertise score vector for software component management. An organization may produce and maintain computer software products for use on computer systems that include multiple software components. Each software component may be assigned a team of developers that are responsible for the software component. Creating software (i.e., developing) for different computer systems that implement relatively complex software components may require specialized knowledge and skills by a software developer. Such knowledge and skills may be gained through experience developing for a particular computer system and/or software component. In order to maintain relatively high quality in software that is produced by an organization, respective expertise score vectors may be maintained for each developer in an organization to identify levels of skills and component mastery for individual developers. Work items may be assigned to developers based on expertise scores that are determined based on the expertise score vectors. For example, a more experienced developer having a higher expertise score may be assigned relatively complex work items, while a less experienced developer having a lower expertise score may be assigned relatively simple work items.

An expertise score vector may include any appropriate metrics regarding a developer, including but not limited to time spent using a technology or skill (i.e., five years using Java, 6 months doing front-end development, etc.), certifications, awards, and/or badges earned, time spent working on a software component, number of lines of code written using a technology, and number of lines of code written in a software component. The expertise score vector may be used to create a vector topology including a subset of metrics that may be used to determine a developer's expertise score for a particular skill or software component. An expertise score may be determined by tracking the various metrics in the expertise score vector, applying respective weights to the metrics that are relevant to the particular software component or skill, adding the weighted metrics to a subset vector, and calculating the magnitude of the subset vector.

Embodiments of an expertise score vector may include a regression testing metric that quantifies how quickly a developer's committed code passes regression testing. If a developer writes code that fails regression, the developer may then fix the issues and resubmit the code for an additional round of regression testing. Regression testing may be repeated a number of times; however, for code that fails regression testing repeatedly, the developer may be adjusting the code just to pass regression, which may result in relatively low quality code. Committed code that passes regression testing with a relatively low number of testing iterations may indicate a higher level of expertise regarding the software component by the developer.

Embodiments of an expertise score vector may include a problem records metric that tracks a number of problem records that have been opened for code written by an individual developer. A developer with a higher number of problem records per line of committed code may have a lower problem records metric value than a developer having a lower number of problem records per line of code. However, it is possible that committed code written by a developer is run relatively infrequently in the deployed software component. For example, if a developer writes code for a code path that is not often exercised, then even if problems exist in the code, a problem record may not be opened for the code. Therefore, the problem records metric for a piece of code may be weighted according to an amount of time that the code has been deployed in the field. A problem record may impact the developer's problem records metric more severely based on the amount of time the code has been deployed, i.e., for code that has been deployed a longer time, a problem record may not impact the problem records metric as much as a problem record corresponding to code that has been deployed a relatively short amount of time. The severity and type of a problem record may also be extracted and used to weigh the effect of the problem record on the developer's problem records metric. For example, a low severity bug or a documentation error may not affect a problem records metric as much as a problem that causes a major loss of functionality.

Before code written by a developer is added to a code base of a software component, another developer may perform a code review of the code. When a developer reviews another developer's code, submits a request for a change, and that change is honored, it may be determined that the reviewing developer has expertise regarding the code. A code review change metric in the expertise score vector may track a number of times change requests by a reviewing developer are implemented in the reviewed code, and the reviewer's expertise score may increase based on the code review change metric. The code review change metric may be decreased based on a number of review change requests by a reviewer that are ignored.

Committed code in a software component may be analyzed for various quality metrics. The analysis may include static analysis and/or linting in some embodiments. One or more code quality metrics may be tracked that include, but are not limited to, a number of comments, degree of code complexity, adherence to convention (e.g., style), and number of code smells. Individual metrics may be weighted based on relative importance (e.g., missing a comment may be weighted lower than introducing an extreme level of code complexity into a software component). The quality metrics may be combined with review comments and automated regression results to determine an overall measurement of code quality. The overall code quality measurement may be determined for an individual developer for a specific software component, or across multiple software components, and may be used to determine the developer's expertise score. Code smells may indicate problems in committed code, as good code may have less code smells than bad code. When a developer submits code, the number of code smells may be calculated, and an average code smell per lines of code can be calculated for the developer and saved in the expertise score vector.

Metrics in an expertise score vector may be weighted such that selected metrics may carry different weights in determining an expertise score of a developer. For example, if time spent working on a particular software component is determined to be less important than time spent using Java for the particular software component, the time for the particular software component metric may be multiplied by a smaller weight (e.g., 0.5) while time spent using Java metric may be multiplied by a larger weight (e.g., 1.15) before the weighted metrics are used to determine an overall expertise score. An overall expertise score may be determined by calculating the magnitude of a subset vector that includes the selected, weighted metrics from the expertise score vector. An overall expertise score may be calculated for a particular skill or software component in some embodiments, such that only metrics in the expertise score vector that are related to the particular skill or software component are used to determine the overall expertise score.

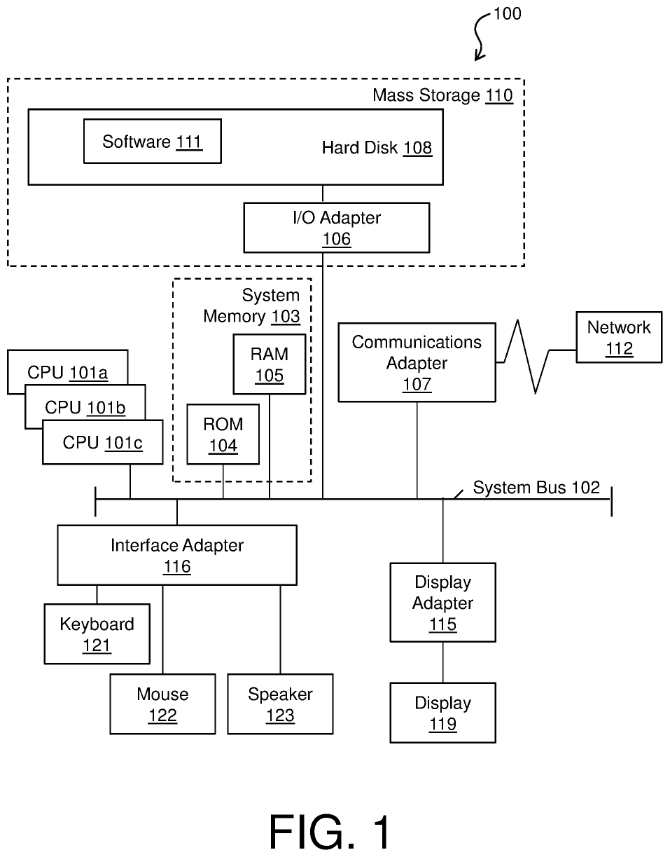

Turning now to FIG. 1, a computer system 100 is generally shown in accordance with an embodiment. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc. (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system, such as the z/OS or AIX operating system from IBM Corporation, to coordinate the functions of the various components shown in FIG. 1.

Additional input/output devices are shown as connected to the system bus 102 via a display adapter 115 and an interface adapter 116 and. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by a display adapter 115, which may include a graphics controller to improve the performance of graphics intensive applications and a video controller. A keyboard 121, a mouse 122, a speaker 123, etc. can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 1, the computer system 100 includes processing capability in the form of the processors 101, and, storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

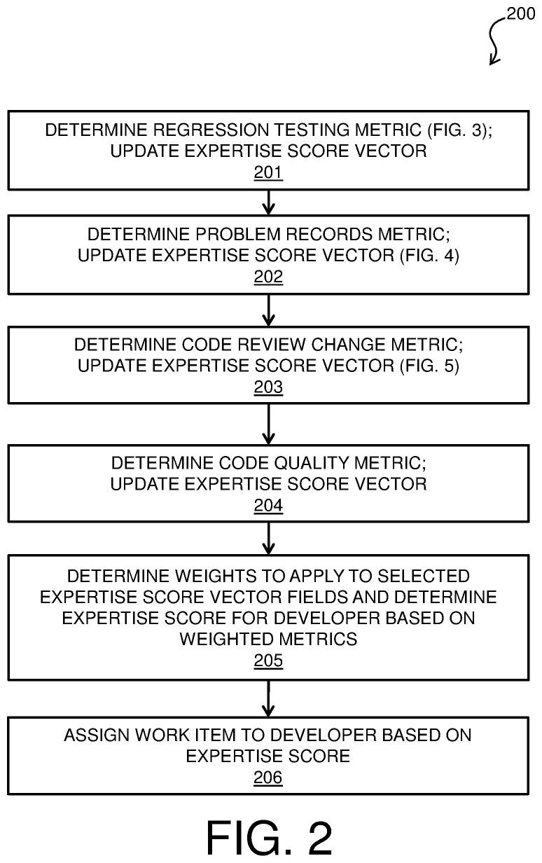

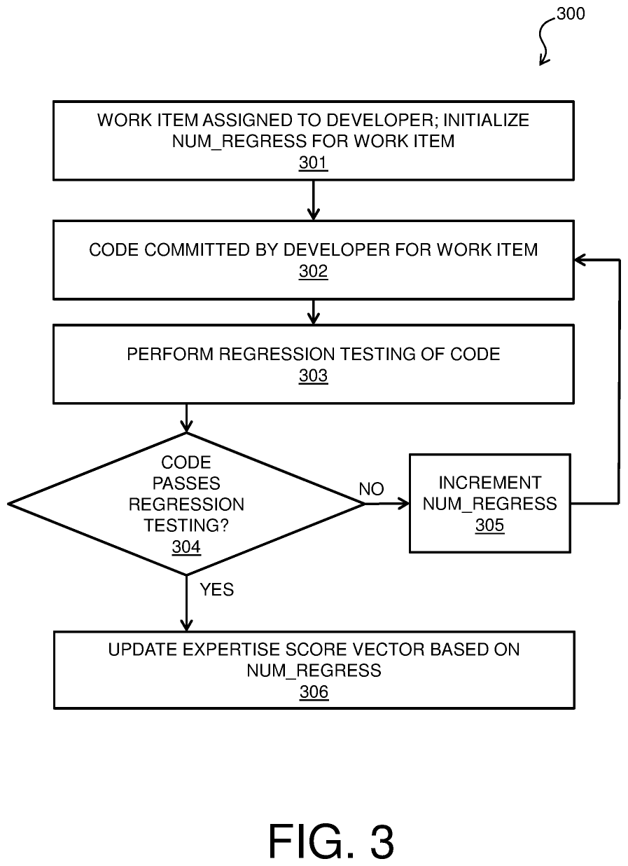

Turning now to FIG. 2, a process flow diagram of a method 200 for software component management using an expertise score vector is generally shown in accordance with one or more embodiments of the present invention. Method 200 may be implemented in conjunction with any appropriate computer system, such as computer system 100 of FIG. 1. In block 201 of method 200, a regression testing metric is determined for a developer, and a regression testing metric in an expertise score vector associated with the developer is updated based on the determination. The regression testing metric may be determined based on a number of attempts required for committed code by the developer to pass regression testing. A relatively large number of attempts required for committed code to pass regression testing may correspond to a lower regression testing metric in some embodiments. Block 201 of method 200 may be triggered based on a developer committing code to any software component, and the committed code being subjected to regression testing. In some embodiments, for a developer that contributes to multiple software components, separate regression testing metrics may be maintained in the expertise score vector for the different software components. Determination of the regression testing metric is discussed below with respect to FIG. 3.

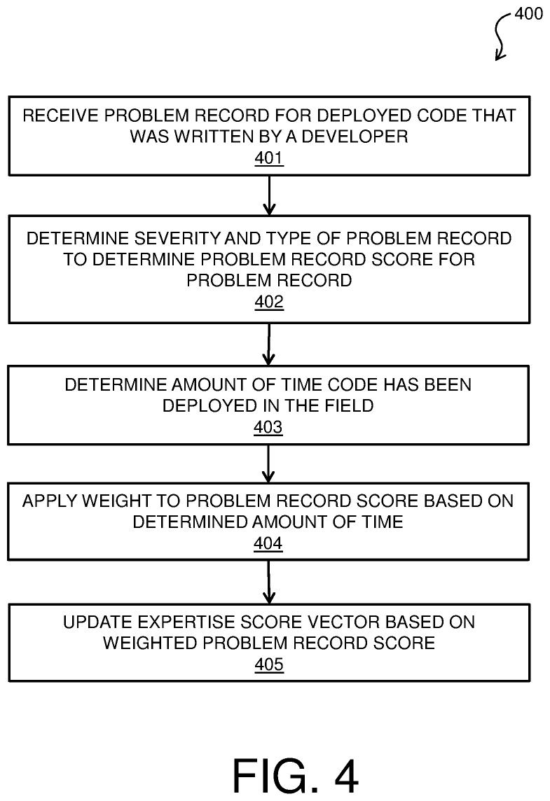

In block 202, a problem records metric is determined for the developer, and a problem records metric in an expertise score vector associated with the developer is updated based on the determination. The problem records metric may be determined based on a problem record being received that corresponds to deployed code that was written by the developer. Block 202 of method 200 may be triggered based on a problem record being received for the developer's code. In some embodiments, for a developer that contributes to multiple software components, separate problem records metrics may be maintained in the expertise score vector for the different software components. Determination of the problem records metric is discussed below with respect to FIG. 4.

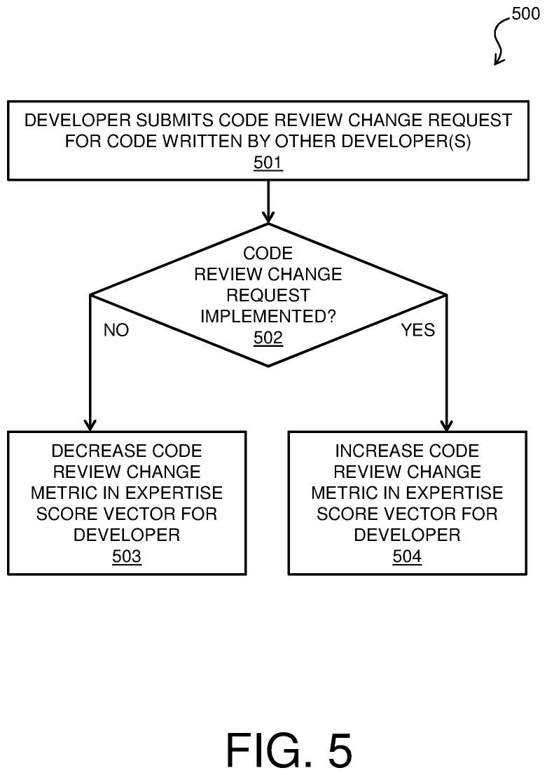

In block 203, a code change review metric is determined for the developer, and a code change review metric in an expertise score vector associated with the developer is updated based on the determination. The code change review metric may be determined for a reviewing developer based on a code review by the reviewing developer of committed code that was written by another developer. Block 203 of method 200 may be triggered based on a reviewing developer submitting a code review change request for committed code that was written by another developer(s). In some embodiments, for a developer that performs code reviews for multiple software components, separate code change review metrics may be maintained in the expertise score vector for the different software components. Determination of the code change review metric is discussed below with respect to FIG. 5.

In block 204, a code quality metric is determined for the developer, and a code quality metric in an expertise score vector associated with the developer is updated based on the determination. The code quality metric may be determined based on a code quality analysis of committed code that was written by the developer. Block 204 of method 200 may be triggered based on a developer committing code to any software component, and the committed code being subjected to code quality analysis. The code quality analysis may include static analysis and/or linting of the committed code in some embodiments. Any appropriate code quality metrics may be determined in block 204, including but not limited to a number of comments, degree of code complexity, adherence to convention (e.g., style), and number of code smells. Individual metrics may be weighted based on relative importance (e.g., missing a comment may be weighted lower than introducing extreme levels of code complexity into a software component). For example, code smells may indicate problems in committed code, as good code may have less code smells than bad code. When a developer commits code for a software component, the number of code smells in the committed code may be automatically calculated in block 204, and an average code smell per lines of code can be calculated for the developer and saved in a code quality metric in the expertise score vector. Code quality metrics may be combined with review comments and automated regression results in some embodiments to determine an overall measurement of code quality. In some embodiments, the code quality metric may include an average number of compile attempts per committed code unit of contribution. In some embodiments, the code quality metric may include an average number of commits per committed code unit of contribution. An overall code quality measurement may be determined for an individual developer for a specific software component, or across multiple software components for a specific skill.

In block 205, respective weights may be applied to selected metric fields in the expertise score vector of the developer, and the selected weighted metrics may be combined to determine an expertise score corresponding to the developer. The selected metrics in an expertise score vector may be weighted such that different metrics may carry different weights in determining the expertise score. For example, if time spent working on a particular component is determined to be less important than time spent using Java for a particular software component, the time for the particular component metric may be multiplied by a smaller weight (e.g., 0.5) while time spent using Java metric may be multiplied by a larger weight (e.g., 1.15) before the weighted metrics are used to determine an overall expertise score for the software component. An expertise score may be determined by calculating a magnitude of a subset vector that includes the set of weighted selected metrics. An expertise score may be calculated for a particular skill or software component in some embodiments, such that only metrics in the expertise score vector that are related to the particular skill or software component are selected and used to determine the expertise score. Any of the metrics that were updated according to blocks 201, 202, 203, and 204 may be selected, and have respective weights applied, to determine an expertise score in block 205.

In block 206, a work item is assigned to the developer based on the expertise score that was determined in block 205. For example, for a work item that is related to a particular software component, an expertise score may be determined for each developer on a team corresponding to the software component in block 206. The expertise scores may be calculated using metrics from each developer's expertise score vector that are determined to be relevant to the particular software component. The work item may then be assigned to a developer from the team based on the calculated expertise scores, e.g., a developer having a highest expertise score may be selected for a relatively complex and/or higher priority work item in block 206, while a developer having a lower expertise score may be selected for a less complex and/or lower priority work item in block 206.

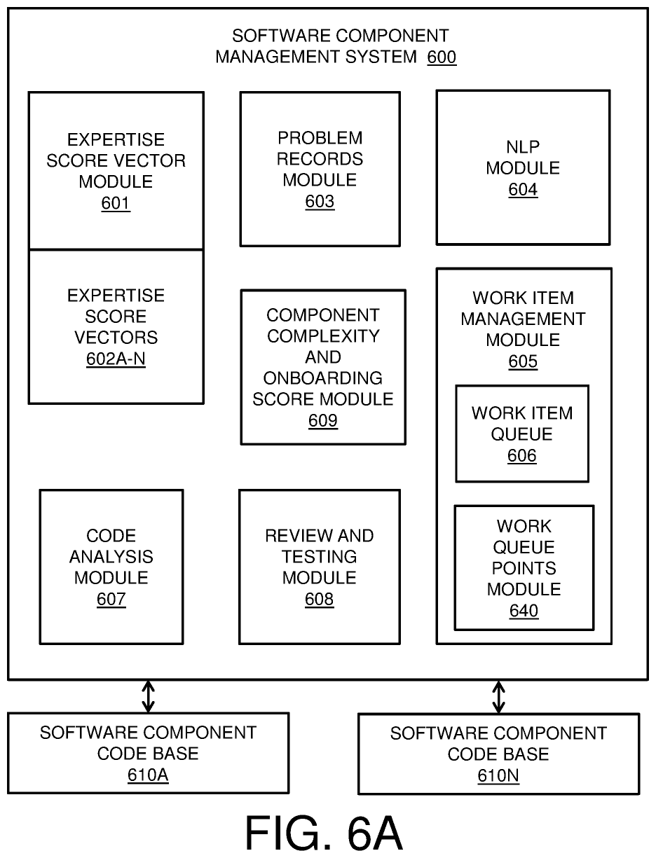

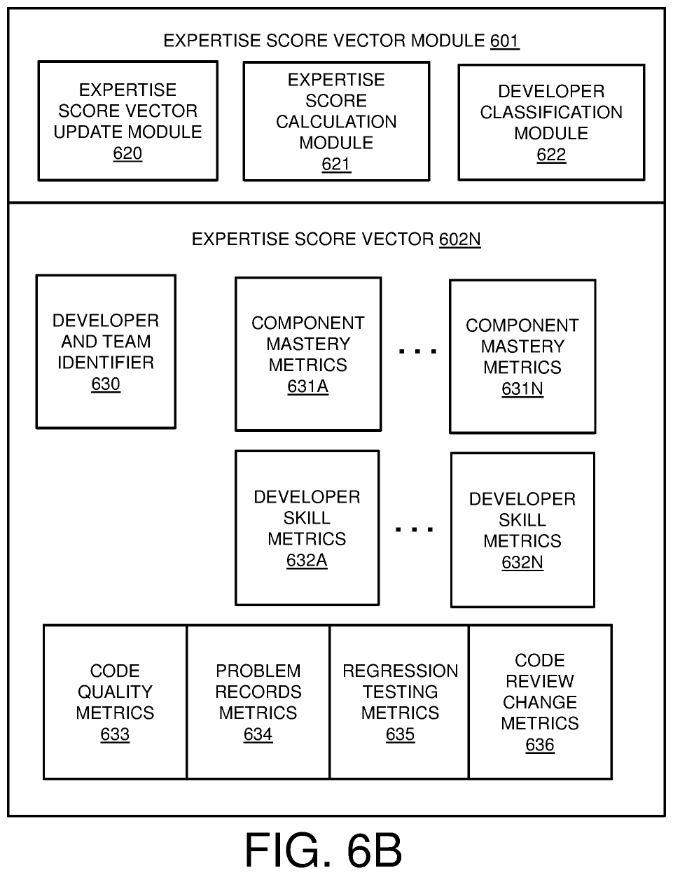

Embodiments of method 200 may be implemented in software component management system 600 of FIG. 6A, which is discussed in further detail below. An embodiment of an expertise score vector, which may be used in conjunction with method 200, is discussed below with respect to FIG. 6B.

The process flow diagram of FIG. 2 is not intended to indicate that the operations of the method 200 are to be executed in any particular order, or that all of the operations of the method 200 are to be included in every case. Additionally, the method 200 can include any suitable number of additional operations.

FIG. 3 shows a process flow diagram of a method 300 for determination of a regression testing metric for an expertise score vector for software component management in accordance with one or more embodiments of the present invention. Method 300 may be implemented in conjunction with any appropriate computer system, such as computer system 100 of FIG. 1, and may be performed in block 201 of method 200 of FIG. 2. In block 301, based on a work item being assigned to a developer, a regression count (NUM_REGRESS) is initialized for the work item. In block 302, code corresponding to the work item is committed by the developer. In block 303, regression testing is performed on the code that was committed in block 302. The regression testing of block 303 may be performed in any appropriate manner. In block 304 it is determined whether the code passed the regression testing of block 303. If the code did not pass the regression testing, flow proceeds from block 304 to block 305, and NUM_REGRESS is incremented. Flow then proceeds from block 305 back to block 302, in which the developer commits corrected code corresponding to the work item based on the failure of the regression testing that was determined in block 304. The corrected code is then regression tested in block 303, and it is determined whether the corrected code passed the regression testing in block 304. Blocks 304, 305, 302, and 303 are repeated until it is determined that the code corresponding to the work item has passed the regression testing in block 304. Based on the code corresponding to the work item passing the regression testing in block 304, flow proceeds from block 304 to block 306, and a regression testing metric in the developer's expertise score vector is updated based on NUM_REGRESS.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

FIG. 4 shows a process flow diagram of a method 400 for determination of a problem records metric for an expertise score vector for software component management in accordance with one or more embodiments of the present invention. Method 400 may be implemented in conjunction with any appropriate computer system, such as computer system 100 of FIG. 1, and may be performed in block 202 of method 200 of FIG. 2. In block 401, a problem record is received for deployed code that was written by a developer. The deployed code may be part of a particular software component. In block 402, the received problem record is processed to determine a severity and type of the problem corresponding to the problem record. The processing may include natural language processing (NLP) to extract keywords from the problem record in some embodiments. A problem record score is determined in block 402 based on the determined severity and type of the problem associated with the problem record that was received in block 401. For example, a low severity bug or a documentation error may correspond to a lower problem record score in block 402 than a problem that causes a major loss of functionality in the software component.

In block 403, an amount of time the code associated with the problem record has been deployed in the field is determined. In block 404, a weight is applied to the problem record score that was determined in block 402 according to the amount of time that was determined in block 403. For example, for code that has been deployed in the field a relatively short amount of time before the problem was discovered and the problem record was generated, the problem record score may be given a higher weight (and correspondingly may decrease the developer's expertise score more) than if the code has been deployed in the field a relatively long amount of time before the problem record was generated. In block 405, a problem records metric in the developer's expertise score vector is updated based on the weighted problem record score that was determined in block 404. In some embodiments, the problem records metric that is updated in block 405 may be associated with the particular software component.

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

FIG. 5 shows a process flow diagram of a method 500 for determination of a code review change metric for an expertise score vector for software component management in accordance with one or more embodiments of the present invention. Method 500 may be implemented in conjunction with any appropriate computer system, such as computer system 100 of FIG. 1, and may be performed in block 203 of method 200 of FIG. 2. In block 501, a reviewing developer submits a code review change request for committed code that was written by one or more other developers. The code review may have been triggered by the committing of the code that is being reviewed. In block 502, it is determined whether the code review change request that was received in block 501 was implemented in the code. For example, if the code review change request is determined to be incorrect by the developer that wrote the reviewed code, the code review change request may not be implemented. If it is determined in block 502 that the code review change request was not implemented, flow proceeds from block 502 to block 503. In block 503, a code change review metric in the expertise score vector corresponding to the reviewing developer is decreased. If it is determined in block 502 that the code review change request was implemented, flow proceeds from block 502 to block 504. In block 504, a code change review metric in the expertise score vector corresponding to the reviewing developer is increased.

The process flow diagram of FIG. 5 is not intended to indicate that the operations of the method 500 are to be executed in any particular order, or that all of the operations of the method 500 are to be included in every case. Additionally, the method 500 can include any suitable number of additional operations.

Turning now to FIG. 6A, a software component management system 600 that includes an expertise score vector is generally shown in accordance with one or more embodiments of the present invention. Software component management system 600 may be implemented in conjunction with any appropriate computer system(s), including but not limited to computer system 100 of FIG. 1. Software component management system 600 is in communication with software component code bases 610A-N, which each include computer code written by one or more developers on teams corresponding to various software components. The software component management system 600 includes an expertise score vector module 601, which may maintain a respective expertise score vector of expertise score vectors 602A-N for each developer across various teams in the organization. Expertise score vector module 601 and expertise score vectors 602A-N are discussed in further detail below with respect to FIG. 6B.

Software component management system 600 includes a problem records module 603, which receives and manages problem records (e.g., bug reports) regarding the software component code bases 610A-N. NLP module 604 performs analysis of problem records that are received by problem records module 603 and may, for example, output keywords that are identified in a problem record to work item management module 605. Work item management module 605 creates work items based on problem records that are received by problem records module 603. The work items may be created by work item management module 605 based on keywords that were identified by NLP module 604 in some embodiments. Work item management module 605 may also create work items based on new feature requests for the software components corresponding to software component code bases 610A-N. Created work items are placed in a work item queue 606 by work item management module 605. The work items in work item queue 606 are assigned to developers by work item management module 605 based on input from expertise score vector module 601 and data from the developers' respective expertise score vectors 602A-N. Work queue points module 640 may track a respective workload for each developer that is currently assigned to any work items in work item queue 606.

When new code is committed by a developer into any of software component code bases 610A-N, code analysis module 607 may review the new code to determine a code quality of the new code. Review and testing module 608 may determine and apply a review and testing process to new code, and may also assign one or more developers to the review and testing process based on expertise score vectors 602A-N. Review and testing module 608 may also provide data regarding the review and testing of code to expertise score vector module 601.

Component complexity and onboarding score module 609 may determine a relative component complexity and an onboarding score for each software component corresponding to software component code bases 610A-N. Component complexity and onboarding score module 609 may operate based on component mastery metrics 631A-N and developer classification module 622 of FIG. 6B, which are discussed below.

Software component management system 600 may implement embodiments of method 200 of FIG. 2. Regression testing metrics, problem records metrics, code review change metrics, and code quality metrics, may be determined by expertise score vector module 601 according to blocks 201-204 of method 200 of FIG. 2, and stored in expertise score vectors 602A-N. Regression testing metrics may be determined by expertise score vector module 601 in block 201 of method 200 of FIG. 2 (according to method 300 of FIG. 3) based on input from review and testing module 608. Problem records metrics may be determined by expertise score vector module 601 in block 202 of FIG. 2 (according to method 400 of FIG. 4) based on input from problem records module 603 and NLP module 604. Code review change metrics may be determined by expertise score vector module 601 in block 203 of method 200 of FIG. 2 (according to method 500 of FIG. 5) based on input from review and testing module 608. Code quality metrics may be determined by expertise score vector module 601 in block 204 of method 200 of FIG. 2 based on input from code analysis module 607. Expertise score vector module 601 may determine an expertise score using a selected set of weighted metrics from an expertise score vector of expertise score vectors 602A-N in block 205 of method 200 of FIG. 2, and a work item from work item queue 606 may be assigned to a developer by work item management module 605 based on the determined expertise score in block 206 of method 200 of FIG. 2.

It is to be understood that the block diagram of FIG. 6A is not intended to indicate that the system 600 is to include all of the components shown in FIG. 6A. Rather, the system 600 can include any appropriate fewer or additional components not illustrated in FIG. 6A (e.g., additional memory components, embedded controllers, functional blocks, connections between functional blocks, modules, inputs, outputs, etc.). Further, the embodiments described herein with respect to system 600 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Turning now to FIG. 6B, an expertise score vector module 601 is generally shown in accordance with one or more embodiments of the present invention. Expertise score vector module 601 of FIG. 6B corresponds to expertise score vector module 601 of FIG. 6A, and manages a plurality of expertise score vectors 602A-N. Expertise score vector module 601 includes an expertise score vector update module 620, which may update any field in an expertise score vector 602N based on data from problem records module 603, work item management module 605, code analysis module 607, and review and testing module 608 in software component management system 600.

Expertise score calculation module 621 may determine an expertise score for a developer based on the developer's expertise score vector 602N. An expertise score may be determined based on any appropriate subset of the fields in expertise score vector 602N, and the various fields in expertise score vector 602N may each be given any appropriate weight in calculating an expertise score. An expertise score may be calculated by expertise score calculation module 621 for a specific skill in some embodiments, such that only fields related to the specific skill are used to calculate the expertise score for the specific skill. In some embodiments, an expertise score that is calculated for a specific skill or software component may be used to assign work items to developers by work item management module 605 as described in blocks 205 and 206 of method 200 of FIG. 2. Developer classification module 622 may determine a classification for a developer based on an expertise score from expertise score calculation module 621. In some embodiments, the developer classification that is calculated by developer classification module 622 may be used to assign work items to developers.

Expertise score vector 602N corresponds to a single developer in an organization. Expertise score vector 602N includes a developer and team identifier 630, which includes a unique identifier of the developer corresponding to expertise score vector 602N, and any teams that the developer is part of. A developer may be part of multiple teams in some embodiments. Expertise score vector 602N includes a plurality of data fields corresponding to the developer.

Expertise score vector 602N may include respective component mastery metrics 631A-N for each software component that the developer has contributed work to. Component mastery metrics 631A-N may include an amount of time required by the developer to produce a unit of contribution to the associated software component. The unit of contribution may be measured in any appropriate manner (e.g. task completed, or lines of code). A number of errors or defects found in committed code by, for example, code analysis module 607 and/or review and testing module 608, that is related to a specific software component may also be tracked. For example, a number of defects detected in code per unit of contribution (e.g., lines of code or number of tasks) for a specific software component may be stored in component mastery metrics 631A-N. The component mastery metrics 631A-N may also include an amount of time spent on the software component, and a total number of contributions made to the software component. Developer classification module 622 may classify the developer with respect to a specific software component based on a set of component mastery metrics 631A, or an overall component mastery metric corresponding to the specific software component. Work items may be assigned to the developer based on the classifications determined by developer classification module 622, and also based on work queue points module 640.

Expertise score vector 602N may include a plurality of developer skill metrics 632A-N. Each individual set of developer skill metrics 632A-N may correspond to a specific skill (e.g., a programming language, a programming technique, such as recursion or multithreading, or a specific hardware element) possessed by the developer. Any appropriate metrics, including skill level and time spent on the skill, may be maintained in the developer skill metrics, such as developer skill metrics 632A, corresponding to a specific skill. Developer skill metrics 632A-N may be used in block 203 of method 200 of FIG. 2, and blocks 303 and 304 of method 300 of FIG. 3, to select developers to assign to a particular work item. The developer skill metrics 632A-N may include any appropriate metrics, including but not limited to a language set (e.g., Java, Python, C, etc.), coding techniques, and code patterns. Developer skill metrics 632A-N may track any appropriate particular techniques or technologies, including but not limited to recursion, loops, thread management, mutex locks, and interfacing with specific subcomponents. The developer skill metrics 632A-N may track a number of commits by the developer per skill to quantify an amount of experience the developer has regarding the skill. A number of errors or defects found in committed code by, for example, code analysis module 607 and/or review and testing module 608, that are related to the skill may also be tracked. For example, a number of defects detected in code per unit of contribution (e.g., lines of code or number of tasks) for a specific skill may be stored in developer skill metrics 632A-N. Errors in code committed that is related to the skill may also be tracked. A code contribution by the developer may be scanned by code analysis module 607 (using, for example, static code analysis and/or NLP) to identify what the code does and any techniques that are implemented in the code contribution, and the developer skill metrics 632A-N may be updated based on the scanning.

Expertise score vector 602N may also include code quality metrics 633, problem records metrics 634, regression testing metrics 635, and code review change metrics 636. Regression testing metrics 635 may be maintained in expertise score vector 602N by expertise score vector update module 620 according to block 201 of method 200 of FIG. 2 and method 300 of FIG. 3. In some embodiments, regression testing metrics 635 may maintain separate regression testing metrics for different software components and/or developer skills. Problem records metrics 634 may be maintained in expertise score vector 602N by expertise score vector update module 620 according to block 202 of method 200 of FIG. 2 and method 400 of FIG. 4. In some embodiments, problem records metrics 634 may maintain separate problem records metrics for different software components and/or developer skills. Code review change metrics 636 may be maintained in expertise score vector 602N by expertise score vector update module 620 according to block 203 of method 200 of FIG. 2 and method 500 of FIG. 5. In some embodiments, code review change metrics 636 may maintain separate code review change metrics for different software components and/or developer skills. Code quality metrics 633 may be maintained in expertise score vector 602N by expertise score vector update module 620 according to block 204 of method 200 of FIG. 2. In some embodiments, code quality metrics 633 may maintain separate code quality metrics for different software components and/or developer skills.

It is to be understood that the block diagram of FIG. 6B is not intended to indicate that the expertise score vector module 601 is to include all of the components shown in FIG. 6B. Rather, the expertise score vector module 601 can include any appropriate fewer or additional components not illustrated in FIG. 6B (e.g., additional memory components, embedded controllers, functional blocks, connections between functional blocks, modules, inputs, outputs, etc.). Further, the embodiments described herein with respect to expertise score vector module 601 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments. Further, expertise score vector 602N is shown for illustrative purposes only. Embodiments of an expertise score vector such as expertise score vector 602N may include any appropriate number and type of data fields in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user' s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
maintaining, by a processor, a plurality of metrics in an expertise score vector corresponding to a developer, wherein the plurality of metrics comprises a problem records metric corresponding to a software component, and wherein maintaining the problem records metric comprises:
receiving a first problem record corresponding to deployed code that was written by the developer for the software component;
determining a problem record score corresponding to the first problem record based on natural language processing of the first problem record; and
updating the problem records metric based on the problem record score;
receiving a second problem record corresponding to the software component;
creating a work item corresponding to the software component based on natural language processing of the second problem record;
identifying a subset of the plurality of metrics that are relevant to the software component;
applying respective weights to the subset of the plurality of metrics;
determining an expertise score for the developer based on the weighted subset of the plurality of metrics, wherein determining the expertise score comprises determining a magnitude of a vector comprising the weighted subset of the plurality of metrics; and
assigning the work item to the developer based on the expertise score.

2-3. (canceled)

4. The computer-implemented method of claim 1, wherein the problem records metric is weighted based on an amount of time the deployed code has been deployed.

5. The computer-implemented method of claim 1, wherein the plurality of metrics comprises a code review change metric, and wherein the code review change metric is determined based on implementation of a code review change submitted by the developer for code that was not written by the developer.

6. The computer-implemented method of claim 1, wherein the plurality of metrics comprises a code quality metric, wherein the code quality metric is determined based on a code quality analysis comprising one of static analysis and linting of committed code written by the developer.

7. The computer-implemented method of claim 6, wherein the code quality metric comprises at least one of a number of comments, a degree of code complexity, adherence to convention, and a number of code smells.

8. A system comprising:
a memory having computer readable instructions; and
one or more processors for executing the computer readable instructions, the computer readable instructions controlling the one or more processors to perform operations comprising:
maintaining a plurality of metrics in an expertise score vector corresponding to a developer, wherein the plurality of metrics comprises a problem records metric corresponding to a software component, and wherein maintaining the problem records metric comprises:
receiving a first problem record corresponding to deployed code that was written by the developer for the software component;
determining a problem record score corresponding to the first problem record based on natural language processing of the first problem record; and
updating the problem records metric based on the problem record score;
receiving a second problem record corresponding to the software component;
creating a work item corresponding to the software component based on natural language processing of the second problem record;
identifying a subset of the plurality of metrics that are relevant to the software component;
applying respective weights to the subset of the plurality of metrics;
determining an expertise score for the developer based on the weighted subset of the plurality of metrics, wherein determining the expertise score comprises determining a magnitude of a vector comprising the weighted subset of the plurality of metrics; and
assigning the work item to the developer based on the expertise score.

9-10. (canceled)

11. The system of claim 8, wherein the problem records metric is weighted based on an amount of time the deployed code has been deployed.

12. The system of claim 8, wherein the plurality of metrics comprises a code review change metric, and wherein the code review change metric is determined based on implementation of a code review change submitted by the developer for code that was not written by the developer.

13. The system of claim 8, wherein the plurality of metrics comprises a code quality metric, wherein the code quality metric is determined based on a code quality analysis comprising one of static analysis and linting of committed code written by the developer.

14. The system of claim 13, wherein the code quality metric comprises at least one of a number of comments, a degree of code complexity, adherence to convention, and a number of code smells.

15. A computer program product comprising a computer readable storage medium having program instructions embodied therewith, the program instructions executable by a processor to cause the processor to perform operations comprising:
maintaining a plurality of metrics in an expertise score vector corresponding to a developer, wherein the plurality of metrics comprises a problem records metric corresponding to a software component, and wherein maintaining the problem records metric comprises:
receiving a first problem record corresponding to deployed code that was written by the developer for the software component;
determining a problem record score corresponding to the first problem record based on natural language processing of the first problem record; and
updating the problem records metric based on the problem record score;
receiving a second problem record corresponding to the software component;
creating a work item corresponding to the software component based on natural language processing of the second problem record;
identifying a subset of the plurality of metrics that are relevant to the software component;
applying respective weights to the subset of the plurality of metrics;
determining an expertise score for the developer based on the weighted subset of the plurality of metrics, wherein determining the expertise score comprises determining a magnitude of a vector comprising the weighted subset of the plurality of metrics; and
assigning the work item to the developer based on the expertise score.

16-17. (canceled)

18. The computer program product of claim 15, wherein the problem records metric is weighted based on an amount of time the deployed code has been deployed.

19. The computer program product of claim 15, wherein the plurality of metrics comprises a code review change metric, and wherein the code review change metric is determined based on implementation of a code review change submitted by the developer for code that was not written by the developer.

20. The computer program product of claim 15, wherein the plurality of metrics comprises a code quality metric, wherein the code quality metric is determined based on a code quality analysis comprising one of static analysis and linting of committed code written by the developer.

21. The computer-implemented method of claim 1, wherein the plurality of metrics comprises a regression testing metric, and wherein maintaining the regression testing metric comprises:
based on first code corresponding to a first work item being committed by the developer, performing regression testing of the first code;
based on the first code failing regression testing, incrementing a number of regression testing attempts corresponding to the first work item;
based on second code corresponding to the first work item being committed by the developer, performing regression testing of the second code; and
based on the second code passing regression testing, updating the regression testing metric based on the number of regression testing attempts corresponding to the first work item.

22. The system of claim 8, wherein the plurality of metrics comprises a regression testing metric, and wherein maintaining the regression testing metric comprises:
based on first code corresponding to a first work item being committed by the developer, performing regression testing of the first code;
based on the first code failing regression testing, incrementing a number of regression testing attempts corresponding to the first work item;
based on second code corresponding to the first work item being committed by the developer, performing regression testing of the second code; and
based on the second code passing regression testing, updating the regression testing metric based on the number of regression testing attempts corresponding to the first work item.

23. The computer program product of claim 15, wherein the plurality of metrics comprises a regression testing metric, and wherein maintaining the regression testing metric comprises:
based on first code corresponding to a first work item being committed by the developer, performing regression testing of the first code;
based on the first code failing regression testing, incrementing a number of regression testing attempts corresponding to the first work item;
based on second code corresponding to the first work item being committed by the developer, performing regression testing of the second code; and
based on the second code passing regression testing, updating the regression testing metric based on the number of regression testing attempts corresponding to the first work item.
